(19) United States
(12) Patent Application Publication
(10) Pub. No.: US 2010/0225461 A1
(43) Pub. Date: Sep. 9, 2010

(54) APPARATUS AND METHOD FOR DETECTION OF A SPECIFIED AUDIO SIGNAL OR GESTURE

(76) Inventor: Raja Singh Tuli, Montreal (CA)

Correspondence Address: Raja Singh Tuli, Suite 1130, 555 Rene Levesque West, Montreal, QC, H2Z 1B1, CA

(21) Appl. No.: 12/398,786

(22) Filed: Mar. 5, 2009

(51) Int. Cl. B60Q 1/00; G01S 3/80; H04B 15/00

(52) U.S. Cl. 340/436; 367/118; 381/94.1

(57) ABSTRACT

The present invention generally relates to an audio signal or gesture detection. More specifically, the invention addresses an apparatus and a method for converting an audio signal detected by microphones or a gesture detected by an image sensing device into a directional indication of the source for the user.

### FIELD OF THE INVENTION

The present invention generally relates to audio signal or gesture detection. More specifically, the invention addresses an apparatus and a method for converting an audio signal detected by microphones or a gesture detected by an image sensing device into a directional indication of the source for the user.

### BACKGROUND OF THE INVENTION

Many situations in modern life require discretional detection of specific words or phrases uttered by individuals where the precise location of the individual is not yet known. Examples include people calling a taxi cab in a crowded or noisy street and people calling police in an equivalent environment.

One of the difficulties is associated with proper speech recognition with enough speed as to make the information useful for locating the source. The presence of background noise and the comparatively low sound pressure level of the calling compound both the detection and recognition of the monitored word or phrase.

In some situations the detection of audio is not possible or convenient, and for these the availability of an image sensing device that could perform a similar detection can either support or replace the audio detection.

The prior art includes several devices and methods that address one or more aspects involved in the present invention, for instance speech recognition, audio signal filtering and enhancing. An example of such prior art is US 2002/0003470 filed by Mitchel Auerbach, addressing the automatic location of gunshots detected by mobile devices. However no specific solution has been provided for the directional detection of a brief, specific word in a crowded and noisy environment which could be converted into a directional indication of the source with the degree of speed and precision required for operability of the present invention. What is needed is means for pinpointing a calling subject based on an audio signal.

### SUMMARY OF THE INVENTION

According to a certain aspect of the present invention, there is disclosed an apparatus for detection of a specified audio signal comprising a plurality of directional microphones for collecting external audio signals from a specific region around the apparatus, connected to a microprocessor for analyzing the external audio signals in search of a specified audio signal, connected to a bearing indicator for indicating the position of the source of the specified audio signal to a user once said specified audio signal is detected, positioned inside a vehicle and connected to the microprocessor, wherein the microphones are fixed to the vehicle, so that the bearing of the source for the specified audio signal can be established based on the orientation of the microphones.

According to a second aspect of the invention, there is disclosed a method for detection of a specified audio signal comprising the steps of collecting the individual audio signals originating from each one of an plurality of fixed, laterally pointed microphones, continually recording the audio input acquired by each microphone and storing it for analysis in an equivalent number of audio buffer files, along with a time reference label, filtering said audio input with the aid of algorithms that combine audio frequency filters, loudness filters and audio envelope filters to screen out background noise, continually comparing the content of the audio buffer files with a pre-recorded sample of a pre-specified trigger word or phrase, once the comparison indicates a match, pinpointing the bearing of the calling subject by means of comparison between the signal intensity profiles as detected by different microphones covering neighboring fields over time, using the directional disposition of each microphone as spatial reference for indicating the audio source bearing, taking the vehicle as spatial reference, relaying such bearing information to the visual bearing indicator and advertising the detection by triggering the sounding of an audio alarm inside the vehicle to alert the user.

According to a third aspect of the invention, there is disclosed an apparatus for detection of a specified gesture comprising an image sensing device for collecting an image signal from a specific region around the apparatus, connected to a microprocessor for analyzing the external image signal in search of a specified gesture, connected to a bearing indicator for indicating the position of a subject executing the gesture to a user once said specified gesture is detected, positioned inside a vehicle and connected to the microprocessor, wherein the bearing of the subject executing the gesture can be established based on the relative position of the subject in the 360° perimeter mapped by the image sensing device, which is fixed to the vehicle.

According to a fourth aspect of the invention, there is disclosed a method for detection of a specified gesture comprising the steps of efficiently mapping the tri-dimensional image input signal of the lens to a bi-dimensional CCD chip which performs the role of an image sensor, registering the image collected through the lens in a bi-dimensional circular range in the CCD chip memory, relaying the image from the CCD chip memory to an image processing unit, cropping out from the image the portion which elevation does not correspond to a vertical arc covering a discrete source which lies anywhere between 5 and 7 feet from the ground and from 1 to 30 meters away from the image sensing unit, continually recording the cropped image input in a video buffer file, along with a time reference label, detecting the target gesture in the buffer file by means of gesture recognition algorithms, once the target gesture is detected, establishing the bearing of the gesturing subject based on the subject's known geometric position in the bi-dimensional circular range of the image processor chip memory, conveying the bearing information to the visual bearing indicator positioned inside a vehicle and triggering the sounding of an audio alarm positioned inside the vehicle.

The above as well as additional features and advantages of the present invention will become apparent in the following written detailed description.

### BRIEF DESCRIPTION OF THE DRAWINGS

A more complete understanding of the present invention may be had by reference to the following detailed description when taken in conjunction with the accompanying drawings, wherein:

FIG. 1 is a perspective view of an aspect of the invention illustrating the external appearance of the audio detector unit;

FIG. 2 is a cross-sectional, side elevation view of an aspect of the invention illustrating the audio feed channels and drainage apertures of the audio detector unit;

FIG. 3 is a diagram illustrating the standard audio detection pattern of a cardioid microphone;

FIG. 4 is a top plan view of an aspect of the invention illustrating the audio detector unit and its audio sourcing field pattern for an exemplary plurality of 4 microphones, showing the result of the interaction with the audio feed channels for each of the 4 detection patterns;

FIG. 5 is a side elevation view of an aspect of the invention illustrating the audio detector unit, its audio sourcing field pattern and the calling subjects at both limits of the range.

FIG. 6 is a perspective view, partially in cross-sectional, of an exemplary shape of the fish-eye type lens that equips the image detection embodiment according to the present invention, with the subjacent CCD chip illustrated beneath it;

FIG. 7 is a plan view of the CCD chip that lies below the fish-eye type lens, with a depiction of the bi-dimensional circular range where the 360° peripheral view from the fish-eye lens is continually registered according to the present invention.

### DESCRIPTION OF THE PREFERRED EMBODIMENTS

The following description requires the previous definition of the concepts of calling subject and trigger word/phrase. The trigger word or phrase is herein defined as the word or phrase which detection is desired. The calling subject is herein defined as the subject who utters the trigger word/phrase.

The first embodiment of the present invention corresponds to a directional finder for a voice signal, typically deployed aboard a vehicle. There are three components involved: An audio detector unit and an audio processing unit positioned outside the vehicle, plus a visual bearing indicator positioned inside the vehicle. The audio detector unit is for example fixed to the roof of a taxi cab, and can alternatively be placed atop of an existing structure such as the taxi signal plate. The positioning of the unit at a high point may contribute to improve the audio sourcing field as discussed in further detail below.

The audio detector and processing units are connected to the bearing indicator either wirelessly or wirily, and communicate bearing information to the bearing indicator inside the car by means of said connection. All three elements are battery powered. Alternatively these could be powered from other available sources such as the car's own battery, solar power, etc.

The audio detector unit typically sits atop the vehicle's roof and incorporates a laterally pointed plurality of directional microphones, each microphone featuring a discrete, static field of detection. In a preferred embodiment, the array comprises three or more individual, directional microphones. The microphones are connected to the vehicle in such a manner that precludes any relative movement between microphone and vehicle, so that the vehicle itself can be employed as inertial referential for the direction indication to be provided by the microphones. Therefore, when a certain audio signal is detected and it is established that such signal came primarily from a specific microphone, the directional disposition of such microphone can be used for indicating the audio source direction taking the vehicle as spatial reference.

A weather protective enclosure is contemplated for the microphone array itself. Microphones are pressure transducers, therefore requiring a certain degree of exposure to the surrounding air in order to perform properly. However the microphones should not be exposed to rain, are susceptible to mechanical damage and excess vibration.

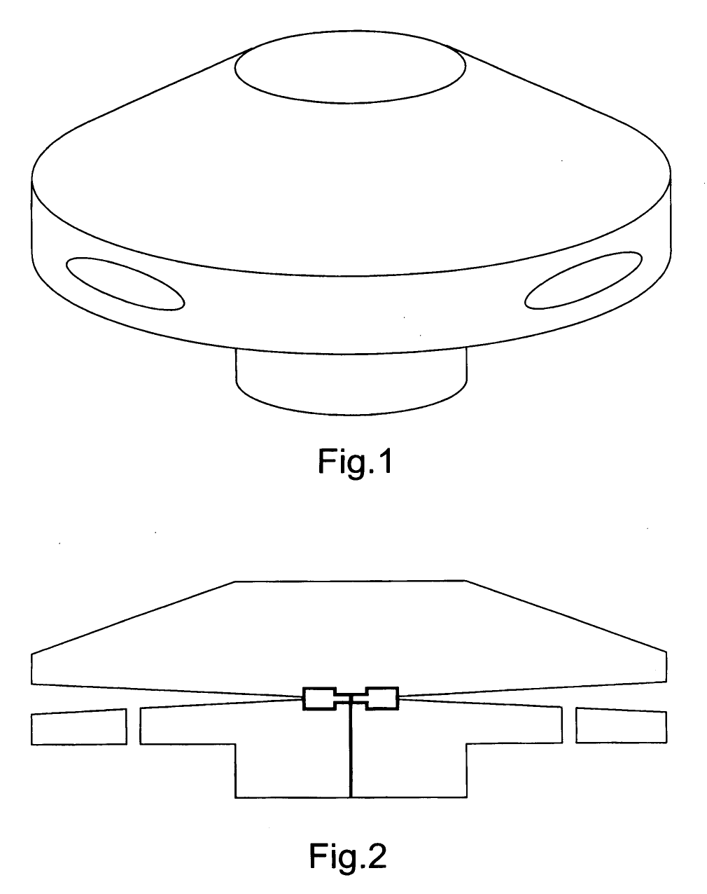

FIGS. 1 and 2 illustrate an exemplary protective enclosure for a plurality of 4 microphones. The external shape is a section of a cylinder with a conical top. Four discrete audio feed channels extend from the lateral, external face of the enclosure to the area near the center of the enclosure where the microphones are positioned. In order to allow drainage of any water that could enter the channel—for instance rain—there is a drainage aperture positioned at the floor of each channel, lying about halfway between the entrance of the channel and the microphone. The drainage is performed with the aid of gravity, the water being lead to an exit aperture at the bottom of the enclosure through a drainage channel. The enclosure illustrated in the Figures is only one of several possible designs conceived to harmonize good protection with the required audio sourcing exposure.

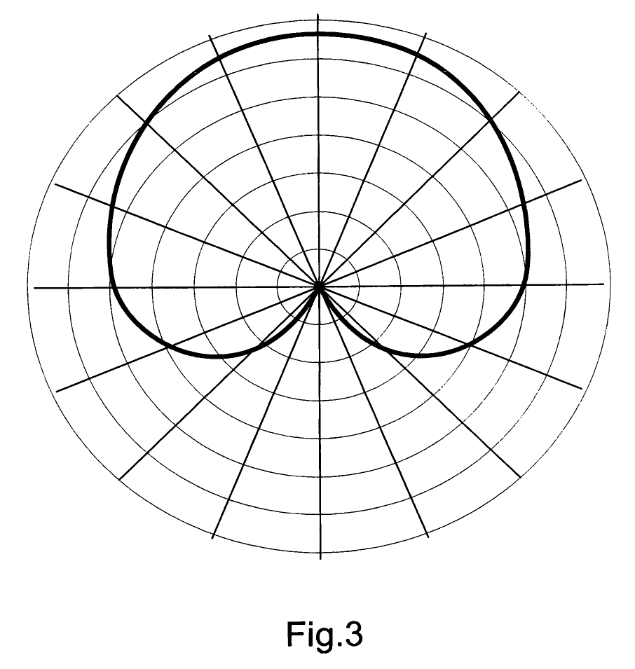

Different types of microphones feature different patterns of audio sensitivity. Considering the importance of directional sensitivity to the purposes of the invention, the choice could be for instance cardioid pattern microphones. These feature a heart-shaped sensitivity pattern, such as the one illustrated in FIG. 3. The audio signals captured by cardioid microphones are mostly concentrated in a heart-shaped pattern around a longitudinal axis pointing ahead, with less sound being captured from the sides and the rear.

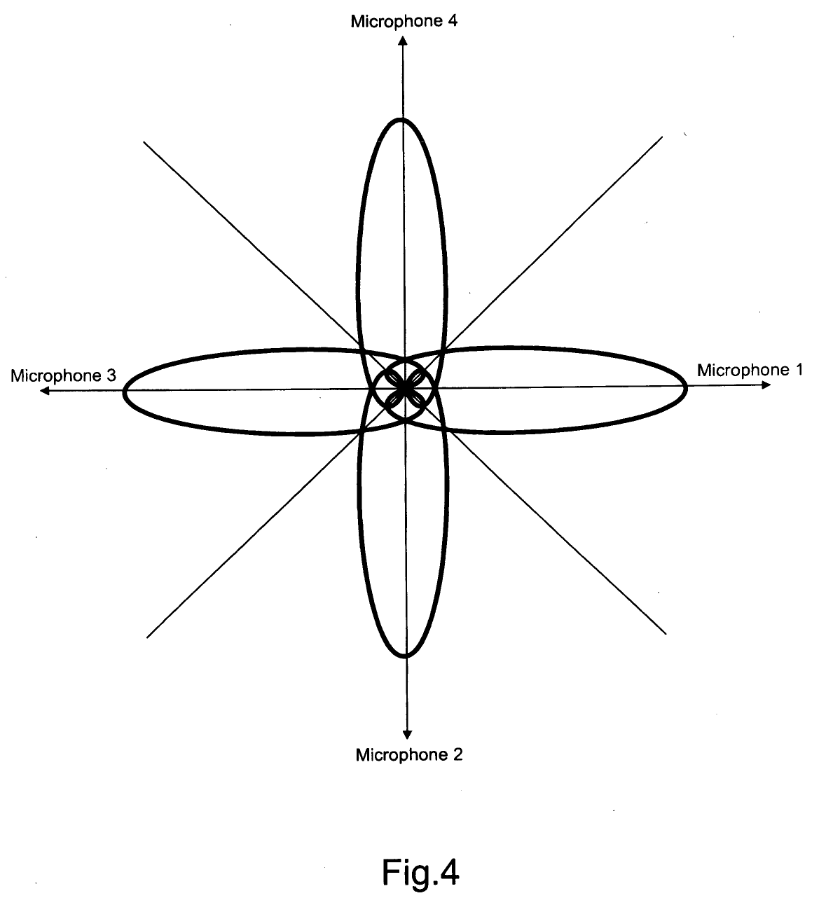

As disclosed above, the array contains multiple microphones. The audio detector unit monitors the input of all microphones simultaneously, keeping track of the individual contribution of each microphone to the overall mass of audio input. As illustrated in FIG. 4, the fields of detection of neighboring microphones overlap each other. This allows pinpointing of the precise direction of the audio signal source by simple association and comparison between the signal intensity profiles as detected by different microphones covering neighboring fields. In other words, the bearing of the audio source is established by means of composition of the audio input fields of different microphones, where the microphone that captured the loudest audio signal is bound to be pointing in the general direction of the source. The concept of audio field composition can be better understood by means of an example: Let us assume a plurality of four microphones such as the one illustrated in FIG. 4, and a calling subject positioned some distance away, right between the axis of neighbouring microphones 2 and 3. Although microphones 1 and 4 may detect a little of the incoming call audio signal—possibly through reflection by surrounding obstacles—the signal intensity as detected by neighbouring microphones 2 and 3 will be much higher. Based on this fact and also considering that the signal intensity on microphone 2 is the same as on microphone 3, the bearing of the calling subject can be correctly estimated as right between the central axis of microphones 2 and 3. In the same example, if the calling subject bearing were to be slightly closer to the central axis of microphone 3, this would be reflected in the signal intensity as detected by microphones 2 and 3, and the bearing “deviation” would be estimated according to the proportion between the different audio signal intensities detected by microphones 2 and 3.

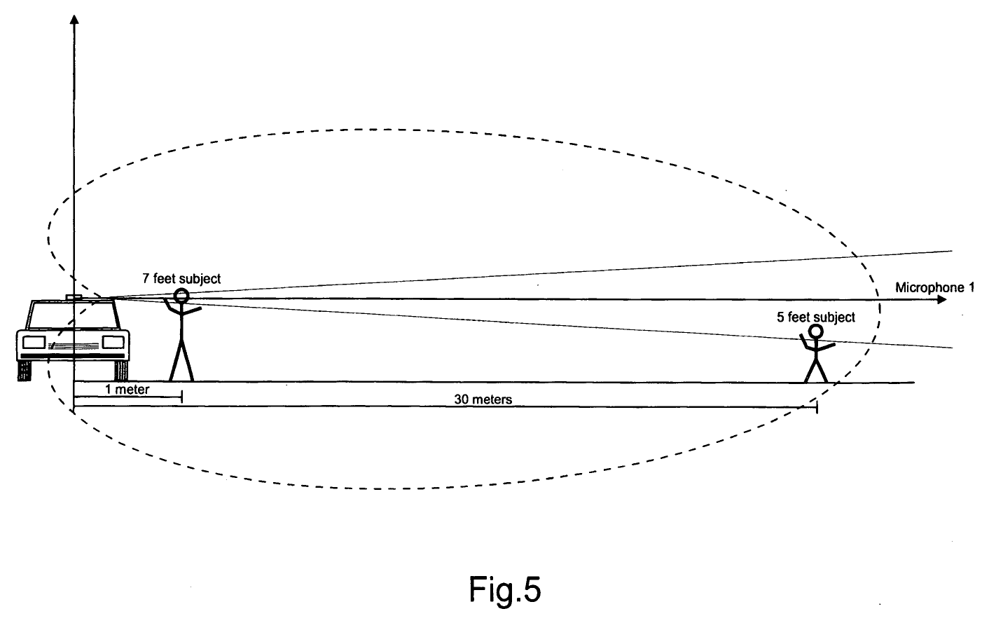

The invention contemplates the focusing of the vertical detection field of said microphone array in a discrete elevation section which corresponds to that of the cranial position of an average-sized adult human standing up on the ground at the same level of the vehicle. In simpler terms, the detection is focused on a horizontal slice of the surrounding audio source field, covering a 360° horizontal arc. In the vertical axis, the range of coverage is custom-adjustable, and typically corresponds to an arc that covers the position of the mouth of a standing adult subject, considering also that the distance between the vehicle and the calling subject can be in a range from 1 to 30 meters. The vertical detection arc is defined considering the geometric consequences of composing different calling subject statures and ranges—the lower limit being a short individual (about 5 feet tall) calling from 30 meters away and the higher limit being a tall individual (about 7 feet tall) calling from 1 meter away. This is best illustrated on FIG. 5, where a dotted line indicates the unfocused audio field that would be covered by a cardioid microphone, while the vertical arc illustrates the actual audio field dictated by the focusing of the audio field which will be detailed further below. The horizontal detection arc for each microphone is defined according to the number of microphones in the array, such that there is a certain amount of overlap between neighboring microphones and the combined array covers the whole 360° around the vehicle. This is best illustrated on FIG. 4.

The positioning of the microphone array at a high point can contribute to optimizing the audio sourcing field, minimizing possible interference by nearby obstacles.

One of the key aspects of the present invention is the optimization of the signal-to-noise proportion in the detected audio input, more specifically by avoiding the capturing of audio components that are undesirable. This contributes to detection performance by “cleaning up” the incoming audio signal. A purposefully streamlined input signal minimizes the excess burden on the audio processing unit with audio signal component portions that are useless for the purposes of the invention.

The aforementioned optimization or “audio focusing” is achieved by a combination of proper microphone choice and the design of the audio feed channels integrated in the weather protective enclosure illustrated on FIG. 2. These channels direct the external audio signal towards the microphones inside the audio detector unit.

The cross-section of the audio feed channels is substantially elliptical, with the vertical dimension being typically smaller than the horizontal one. The vertical and horizontal dimensions of the audio feed channels are specifically dimensioned to minimize the collection of audio signals coming from directions known not to correspond to that of the calling subject and thus enhance the signal-to-noise proportion of the audio that actually reaches the microphones. The cross-section also tapers towards the microphone, effectively giving the channel the shape of an elliptical cone, with the larger section on the surface of the weather protective enclosure and the apex close to the center of the enclosure where the microphones are positioned.

The internal surface of the audio feed channel is lined with audio absorbing material such as foam or other heterogeneous material. The purpose of said lining is to minimize the amount of sound wave reflection inside the channel, such that the major part of the audio signal actually reaching the microphones is directly incident audio originating from the “virtual extension” of the cone-shaped channel. The resulting combination of the audio feed channel's elliptical cone shape with the audio absorbing lining of the cone is the desired focusing of the audio sourcing field, which optimizes detection performance. The result of the interaction between an original, unchanelled cardioid detection pattern—such as the one illustrated on FIG. 3—and the audio feed channels described above can be best seen on FIG. 4, in which the sensitive pattern of each microphone in the array is narrowed by the dimensions of its corresponding audio feed channel.

The horizontal dimension of the audio feed channels' cross section is specifically chosen according to the number of microphones in the array, such that the plan view of the conical channel corresponds to the horizontal detection arc.

The vertical dimension of the audio feed channels' cross section is similarly chosen, such that the side elevation view of the conical channel corresponds to the desired vertical detection arc. Thus the portion of the audio that comes from directions which are known not to contain the desired source—such as ground reflections, etc.—is cut out, while the audio coming from the already described arc containing the mouth of a standing adult subject ranging from 5′ to 7′ in height and between 1 and 30 meters away is granted direct access to the microphones at the apex of the conical audio feed channels.

The audio input acquired by each microphone in the microphone array is continually recorded and stored for analysis in an equivalent number of audio buffer files, along with a time reference label. A recording/erasing algorithm incorporated in the audio detector unit erases the older portion of this audio buffer file with a specific delay regarding the recording. Thus a discrete length of recorded audio—for instance the last 5 seconds—is made continually available for analysis, whereas any portion older than 5 seconds is continually erased. This arrangement eliminates the need for large capacity of data storage in the audio detector unit, while still providing a continually updated sample that is long enough for the purposes of the invention. Alternatively a standard FiFo (first in, first out) buffer arrangement could be used.

The audio processing engine is integrated in the audio processing unit microprocessor. This processor is continually sampling the content of the audio buffer file, which stores the constantly updated input acquired by each microphone in the microphone array. The audio processing engine monitors this audio content for the presence of a particular trigger word or phrase. Once the trigger word/phrase is detected in the audio input signal, the processor combines the information of each microphone's signal strength with its geometric position in the microphone array. Applying the audio field composition method explained above, the audio processing engine establishes the bearing of the calling subject.

The detection process makes use of specialized algorithms which purpose is to improve detection performance. These algorithms further improve the signal-to-noise proportion already addressed by the design of the audio feed channels in the weather protective enclosure. This is done minimizing portions of the incoming audio signal which are known not to contain the trigger word or phrase which detection is sought. These algorithms contemplate combinations of audio frequency filters, loudness filters and audio envelope filters. The frequency filters are employed to screen-out portions of the audio which frequency is either too low (e.g. street rumble, wind) or too high (e.g. sirens, horns), selectively dampening these frequencies without affecting the frequency band known to contain the typical range of a human voice calling the trigger word/phrase. The loudness filter is employed in a similar way, dampening those portions of the signal which volume is higher or lower than the typical range expected for the trigger word/phrase. The successive dampenings by frequency and loudness performed by the microprocessor yield a signal where it is easier to spot the trigger word/phrase against the background noise. The audio envelope filter is applied on the principle that the trigger word/phrase has its own specific profile of audio frequency spectrum over time, like an “audio map” of frequency pulses over the time required for the average subject to say the trigger word/phrase. The audio signal processor continually monitors the frequency/loudness filtered audio signal, searching for a similar envelope. Consistency is a major concern whenever envelope filters are employed. For that reason the audio envelope filter features a user-set similarity threshold.

The user can also set specific patterns targeting audio recognition of one or more specific words, each word in a discrete range of frequency, loudness and period. Dynamic aspects of speech such as intonation can also be contemplated in the algorithm. The algorithm's programmability contemplates the many differences in the expected audio signal regarding language, accent and other local factors. An alternative embodiment of the present invention has an extra algorithm incorporating a Doppler effect compensator. The frequency of the audio input will vary along the time because of the relative movement between the vehicle and the calling subject. In a rate determined by the relative speed between the vehicle and the calling subject, the frequency will suffer an increase while the vehicle is moving closer to the calling subject and a decrease while the vehicle is moving away from the calling subject. The Doppler effect compensator receives continual readings from the vehicle's speedometer and factors this into a coefficient. This coefficient is applied to both the top and bottom limits of the target frequency band where the processing engine looks for the trigger word or phrase, effectively preventing detection performance decrease due to Doppler effect “masking” of the calling subject's voice frequency.

Once the trigger word/phrase is spotted in the input audio signal, the time reference label of the various contributing microphones is analyzed and the bearing of the calling subject is established. As explained before, the analysis of the composition of the audio input fields of different microphones allows a reasonably precise estimation of calling subject bearing, which is then relayed to the visual bearing indicator for display to the user, taking the vehicle as spatial reference.

The audio source pinpointing is performed in almost real time, with very little delay between the moment when the microphone array collects the audio input signal containing the trigger word/phrase and the output of the corresponding directional information by the audio detector unit's microprocessor. In an alternative embodiment, the processor calculates a positional update of the audio source as related to the moving vehicle. It does so by computing data on the speed and direction of the vehicle and the difference in the signal intensity profile as detected by neighboring microphones over time. The result of said calculation is used to estimate the actual, relative position of the audio source and include this forecasted adjustment upon displaying this information in the visual bearing indicator inside the vehicle.

As soon as the audio detector unit relays the detection information to the bearing indicator, an audio alarm—for instance a beep—is sounded inside the vehicle to call the driver's attention to the visual bearing indicator. The visual bearing indication provided for the driver inside the vehicle can include for instance a LED display panel or even a mechanical indicator that rises from the dashboard between the driver and the windshield, said visual indication providing both notice of the trigger word/phrase detection and the corresponding bearing. As the bearing indicated by the visual bearing indicator relates to the vehicle itself, all the driver needs to do is look towards said bearing to acquire visual identification of the audio signal source.

An alternative embodiment incorporates a simple menu of pre-recorded audio messages that can be used to provide audible indication of the bearing for the driver. Said audio indication that is broadcast by the bearing indicator inside the vehicle can be added to or even replace the visual indication. The bearing indicated by the microphone array is given using the car itself as directional reference. The audio indication minimizes the risk of distraction of the driver in a possibly critical situation, as the audio signal does not interfere with the driver's ability to keep looking at the traffic ahead. As the audio conveys to the driver the relative position of the calling subject, the driver is able to initiate the maneuvering of the vehicle towards the indicated bearing without actually needing to look in that direction. In conditions such as poor visibility, heavy traffic or relatively fast lanes this feature becomes fundamental for a safe system operation.

Another alternative embodiment incorporates a feedback indication to the calling subject. Simple projector means, positioned on the internal face of the vehicle's roof and connected to the bearing indicator—either wirily or wirelessly—project a feedback message on one of the vehicle windows, namely one that can be seen by the subject. Said feedback message can be for instance “I saw you”, which acknowledges the call and contributes to the accomplishment of a safe boarding by means of effective communication between the driver and the calling subject.

If two or more subjects happen to call at the same time, multiple detections will ensue. According to the present invention, the call with the loudest signal will be construed as the nearest, and any other call detected from a different direction will be ignored by the audio processing engine.

Thus according to the present invention, once the calling subject utters the trigger word or phrase in a range of 1 to 30 meters from the vehicle, the audio signal generated by his/her voice diffuses through the air and is collected by one or more of the audio feed channels. The signals captured by each one of the various microphones in the audio detector unit's array are recorded, filtered and analyzed with the aid of specialized algorithms running in the audio processing unit. Once comparison to a pre-recorded sample indicates detection of the trigger word or phrase, the bearing of the calling subject is established by means of comparison between the signal intensity profiles as detected by different microphones covering neighboring fields over time, using the directional disposition of each microphone as spatial reference for indicating the audio source bearing. The bearing information, taking the vehicle as spatial reference, is then relayed to the visual bearing indicator inside the vehicle. The detection of a call is advertised by the triggering of an audio alarm to alert the user inside the vehicle, while the directional information is conveyed by the lighting of a particular LED in the visual bearing indicator. Alternatively a pre-recorded audio message is sounded inside the vehicle, communicating the bearing information to the user, and feedback is provided to the calling subject by projecting a feedback message on one of the vehicle windows, acknowledging detection of the call.

The second embodiment of the present invention is also typically deployed aboard a vehicle, but is based on image instead of audio. An image sensing device constantly scrutinizes the visual field around the vehicle, looking for a particular gesture performed by a calling subject, for instance a raised arm with a waving hand. This is termed the target gesture. This embodiment's purpose is essentially the same as the one described for the first embodiment, only instead of detecting an audio signal—for instance the word “taxi” spoken by the calling subject—it detects a particular gesture as performed by said calling subject under the same conditions. Just like in the first embodiment, typical applications of this image-based embodiment would include people gesturing with the purpose of calling a taxi cab in a crowded street and people gesturing to call police help in a similar environment.

The hardware employed in the gesture detection is incorporated in an image sensing unit positioned outside the vehicle, in a position that affords an unobstructed line of sight to the space surrounding the vehicle. The image sensing unit is connected to a microprocessor equipped image processing unit positioned outside the vehicle, connected to a visual bearing indicator which may be the very same described above in the embodiment based on audio detection.

The image sensing unit incorporates a special, aspherical, plastic, semi-hemispheric design fish-eye type lens such as the one illustrated in FIG. 6. This single lens input field covers a detection band composed by the whole 360° horizontal detection arc around the lens and a purposively selected vertical detection arc of a certain extension. This specialized fish-eye type lens is similar to those used in security cameras, but is designed to cover little more than a specific vertical detection arc. Focus in said specific detection band—which is the only portion of the visual field that is relevant for the purposes of the invention as explained further below—is optimized for a range between 1 and 30 meters away from the lens, while the portion of the input image lying outside the detection band is distorted by naturally occurring optical phenomena. The lens is fixed and therefore its position regarding the vehicle itself is constant.

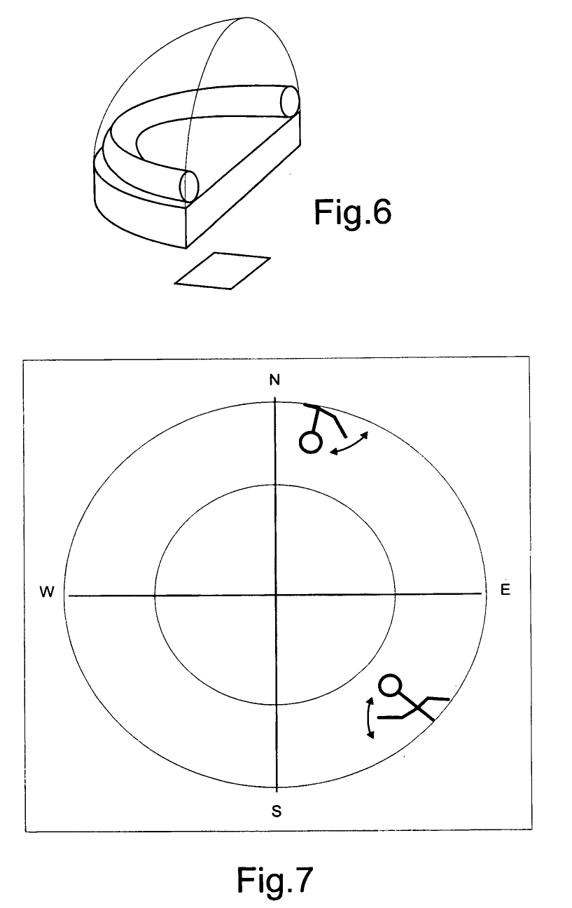

The lens efficiently maps the tri-dimensional image input signal to a bi-dimensional CCD (charge coupled device) chip which performs the role of an image sensor. The chip registers the image collected through the lens in a bi-dimensional circular range such as the one illustrated in FIG. 7. The CCD chip has a memory and is connected to the image processing unit, either wirily or wirelessly.

Depending on the specific application, the target gesture is expected to occupy a corresponding range in the vertical direction. For the purpose of exemplary description, let us assume that the target gesture involves the raising of an arm above the head and waving: In such a case, the vertical detection arc must comprise the elevation section ranging from the mid-torso up until about a foot above the top of the head of an average-sized adult human standing up on the ground at the same level of the vehicle. It must also consider that the distance between the vehicle and the gesturing subject can be in a range from 1 to 30 meters. Therefore the vertical detection arc of the lens is defined considering the geometric consequences of composing different gesturing subject statures and ranges—the lower limit being a short individual gesturing 30 meters away from the lens and the higher limit being a tall individual gesturing 1 meter away from the lens. This is best illustrated on FIG. 5.

In an alternative embodiment of the present invention, the height of the image band covered by the lens' vertical detection arc can be minimized via software, so that the image actually forwarded for further processing is actually a narrower portion of the image actually acquired by the lens. This cropping out of the image contributes to minimizing the workload on the video buffer and the processing engine that are detailed further below.

This flattened-out impression of the surrounding image source field registered in the CCD chip memory of the image processing unit is continually recorded and stored for analysis in a video buffer file, along with a time reference label. A recording/erasing algorithm incorporated in the image sensing unit erases the older portion of this video buffer file with a specific delay regarding the recording. Thus a discrete length of recorded video—for instance the last 5 seconds—is made continually available for analysis, whereas any portion older than 5 seconds is continually erased. This arrangement eliminates the need for large capacity of data storage in the image sensing unit, while still providing a continually updated sample that is long enough for the purposes of the invention. Alternatively a standard FiFo (first in, first out) buffer arrangement could be used.

In order to identify the target gesture in the environment surrounding the vehicle and indicate its bearing to the driver, the device must first recognize the target gesture in the video buffer file. The recognition of the gesture can be performed by several different manners, including gesture recognition algorithms, sample-based recognition routines, etc. The recognition is facilitated by the fact that the orientation of the subject is known on every sector of the flattened out, bi-dimensional image registered in the video buffer file.

Once the target gesture is detected in the video buffer file, the video processing engine is able to establish the general direction of the gesturing subject based on the subject's known geometric position in the bi-dimensional circular range of the image processor chip memory. For example, a subject that appears on the bi-dimensional image of the video buffer file at 60° NW has its bearing relayed to the visual bearing indicator inside the car as 60° NW.

In an alternative embodiment of the invention the fish-eye type lens can be replaced by a plurality of multiple conventional lenses covering discrete lateral fields, with each lens covering a discrete, static field of view. The fields of view of neighboring lenses slightly overlap each other.

In a further alternative embodiment of the invention, a specialized algorithm run by the image processing unit compensates for the anticipated reduction of the gesturing subject image due to the relative movement between the vehicle and the subject.

Thus according to the present invention, once the calling subject performs the target gesture in a range of 1 to 30 meters from the vehicle, the image of said gesture is captured by the image sensing device deployed atop of the vehicle. The image signal captured by the lens is mapped to a bi-dimensional CCD chip which performs the role of an image sensor. The chip registers the image in a bi-dimensional circular range and relays it to an image processing unit. The image processing unit crops out from the image the portion which elevation does not correspond to a vertical arc covering a discrete source which lies anywhere between 5 and 7 feet from the ground and from 1 to 30 meters away from the image sensing unit. The image processing unit continually records the cropped image in a video buffer file, along with a time reference label. The detection of the target gesture in the buffer file is then performed by means of gesture recognition algorithms or equivalent means. Once the target gesture is detected, the bearing of the gesturing subject is established based on the subject's known geometric position in the bi-dimensional circular range of the image processor chip memory. The bearing information, taking the vehicle as spatial reference, is then relayed to the visual bearing indicator inside the vehicle. The detection of a target gesture is advertised by the triggering of an audio alarm to alert the user inside the vehicle, while the directional information is conveyed by the lighting of a particular LED in the visual bearing indicator. Alternatively a pre-recorded audio message is sounded inside the vehicle, communicating the bearing information to the user, and feedback is provided to the calling subject by projecting a feedback message on one of the vehicle windows, acknowledging detection of the call.

The third embodiment of the present invention combines the audio and image systems together.

While this invention has been particularly shown and described with reference to a preferred embodiment, it will be understood by those skilled in the art that various changes in form and detail may be made therein without departing from the spirit and scope of the invention.

I claim:

1. Apparatus for detection of a specified audio signal comprising:
a plurality of directional microphones for collecting external audio signals from a specific region around the apparatus, connected to
a microprocessor for analyzing the external audio signals in search of a specified audio signal, connected to
a bearing indicator for indicating the position of the source of the specified audio signal to a user once said specified audio signal is detected, positioned inside a vehicle and connected to the microprocessor;
wherein the microphones are fixed to the vehicle, so that the bearing of the source for the specified audio signal can be established based on the orientation of the microphones.

2. Apparatus according to claim 1 wherein:
the plurality of microphones is integrated in an audio detector unit covered by a weather protective enclosure, the plurality of microphones is substantially horizontal and laterally pointed, each microphone featuring a discrete, static field of detection, the audio detector unit being connected to
an audio processing unit which incorporates the microprocessor,
the bearing indicator incorporates an integrated audio alarm and visual display means, both positioned inside a vehicle;
a plurality of discrete audio feed channels is radially distributed throughout the body of the weather protective enclosure for directing the external audio signal towards the microphones, each channel extending from the lateral, external face of the enclosure towards the centrally positioned audio detector unit;
an audio buffer memory is integrated in the audio detector unit circuitry, and
an audio processing engine runs in the microprocessor.

3. Apparatus according to claim 2 wherein the internal surface of each audio feed channel is lined with audio absorbing material for minimizing the amount of sound wave reflection inside the channel.

4. Apparatus according to claim 2 wherein the cross section of each feed channel tapers towards the audio detector unit, forming an elliptical cone, with the larger section on the surface of the weather protective enclosure and the apex close to the audio detector unit, the external aperture having the shape of an ellipse.

5. Apparatus according to claim 4 wherein the elliptical cross section of the channel has its height dimensioned to collect non-reflected audio from a discrete source which lies anywhere between 5 and 7 feet from the ground and from 1 to 30 meters away.

6. Apparatus according to claim 4 wherein the elliptical cross section of the channel has its width dimensioned to collect non-reflected audio from a discrete source which lies anywhere inside a specified horizontal detection arc, defined according to the number of microphones in the array such that there is a known amount of overlap between neighboring microphones sourcing field and the combined array covers the whole 360° of a substantially horizontal plan around the audio detector unit.

7. Apparatus according to claim 2 wherein there is a drainage aperture positioned at the floor of each audio feed channel, lying about halfway between the entrance of the channel and the audio detector unit, connected to a drainage channel that leads any drained liquid to a bottom aperture in the weather protective enclosure.

8. Apparatus according to claim 2 wherein the bearing indication provided for the driver inside the vehicle includes a LED display panel that provides visual indication of the bearing of the calling subject taking the vehicle as directional reference.

9. Apparatus according to claim 2 wherein the bearing indication provided for the driver inside the vehicle includes pre-recorded audio messages used to provide audible indication of the calling subject bearing.

10. Apparatus according to claim 2 further comprising a feedback indication to the calling subject in the form of projection means positioned inside the vehicle and connected to the visual bearing indicator, projecting a feedback message on one of the vehicle windows to acknowledge detection of a call.

11. Apparatus according to claim 2 wherein the audio detector unit and the audio processing unit are positioned outside the vehicle.

12. Apparatus according to claim 2 wherein the microphones are connected to the vehicle in such a manner that precludes any relative movement between microphone and vehicle, so that the vehicle itself can be employed as inertial referential for the direction indication to be provided by the microphones.

13. Apparatus according to claim 2 wherein the audio detector unit, the audio processing unit and the visual bearing indicator are battery powered.

14. Apparatus according to claim 2 wherein the audio detector unit, the audio processing unit and the visual bearing indicator are powered by the vehicle's own battery.

15. Apparatus according to claim 2 wherein the audio detector unit, the audio processing unit and the visual bearing indicator are solar powered.

16. Apparatus according to claim 2 wherein the visual display means comprise a set of radially distributed LED indicators.

17. Method for detection of a specified audio signal comprising the steps of:
collecting the individual audio signals originating from each one of an plurality of fixed, laterally pointed microphones;
continually recording the audio input acquired by each microphone and storing it for analysis in an equivalent number of audio buffer files, along with a time reference label;
filtering said audio input with the aid of algorithms that combine audio frequency filters, loudness filters and audio envelope filters to screen out background noise;
continually comparing the content of the audio buffer files with a pre-recorded sample of a pre-specified trigger word or phrase;
once the comparison indicates a match, pinpointing the bearing of the calling subject by means of comparison between the signal intensity profiles as detected by different microphones covering neighboring fields over time, using the directional disposition of each microphone as spatial reference for indicating the audio source bearing, taking the vehicle as spatial reference;
relaying such bearing information to the visual bearing indicator and
advertising the detection by triggering the sounding of an audio alarm inside the vehicle to alert the user.

18. Method according to claim 17, further comprising the step of generating a feedback indication to the calling subject by projecting a feedback message on one of the vehicle windows to acknowledge detection of a call.

19. Method according to claim 17, further comprising the step of sounding pre-recorded audio messages inside the vehicle to provide audible indication of the calling subject bearing.

20. Method according to claim 17, wherein the audio input acquired by each microphone is continually recorded and stored for analysis in an equivalent number of audio buffer files, being said buffer files continually erased with a pre-specified delay for minimizing the required data storage capacity in the audio detector unit.

21. Method according to claim 17 wherein the audio processing algorithm incorporates an audio envelope filter featuring a user-set similarity threshold.

22. Method according to claim 17 wherein the audio processing algorithm incorporates a Doppler effect compensator.

23. Method according to claim 22 wherein the Doppler effect compensator receives continual readings from the vehicle's speedometer and factors this into a coefficient, said coefficient being applied to both the top and bottom limits of the target frequency band where the processing engine looks for the trigger word or phrase, effectively preventing detection performance decrease due to Doppler effect masking of the calling subject's voice frequency.

24. Method according to claim 17 wherein the audio signal processor calculates a positional update of the audio source as related to the moving vehicle by computing data on the speed and direction of the vehicle and the difference in the signal intensity profile as detected by neighboring microphones over time, being the result of said calculation used to estimate the actual, relative position of the audio source, said forecasted adjustment being relayed to the bearing indicator deployed inside the vehicle.

25. Method according to claim 17 wherein if two or more subjects happen to call at the same time, the call with the loudest signal is construed as the nearest, and any other call detected from a different direction is ignored by the audio processing engine.

26. Apparatus for detection of a specified gesture comprising:
an image sensing device for collecting an image signal from a specific region around the apparatus, connected to
a microprocessor for analyzing the external image signal in search of a specified gesture, connected to
a bearing indicator for indicating the position of a subject executing the gesture to a user once said specified gesture is detected, positioned inside a vehicle and connected to the microprocessor;
wherein the bearing of the subject executing the gesture can be established based on the relative position of the subject in the 360° perimeter mapped by the image sensing device, which is fixed to the vehicle.

27. Apparatus according to claim 26, wherein:
the image sensing unit incorporates a lens and a bi-dimensional CCD chip, covered by a weather protective enclosure;
an image processing unit is connected to the CCD chip and includes the microprocessor,
the bearing indicator integrates audio alarm and visual display means, positioned inside a vehicle;
a video buffer memory is integrated in the image processing unit for recording the image input along with a time reference label before further processing, and
an image processing engine runs in the microprocessor, and
the lens is connected to the vehicle in such a manner that precludes any relative movement between the lens and the vehicle.

28. Apparatus according to claim 27 wherein the lens is an aspherical, plastic, semi-hemispheric purpose-designed fish-eye type lens with an image input field covering the whole 360° horizontal detection arc around the lens and a purposively selected vertical detection arc of a certain extension, the lens efficiently mapping the collected image to a portion of a bi-dimensional CCD chip.

29. Apparatus according to claim 27 wherein the focus in the field of view covered by the lens is optimized for a range between 1 and 30 meters away from the lens.

30. Apparatus according to claim 27 wherein the fish-eye type lens is replaced by a plurality of multiple conventional lenses covering discrete lateral fields, with each lens covering a discrete, static field of view and the fields of view of neighboring lenses slightly overlapping each other.

31. Method for detection of a specified gesture comprising the steps of:
efficiently mapping the tri-dimensional image input signal of the lens to a bi-dimensional CCD chip which performs the role of an image sensor;
registering the image collected through the lens in a bi-dimensional circular range in the CCD chip memory;
relaying the image from the CCD chip memory to an image processing unit;
cropping out from the image the portion which elevation does not correspond to a vertical arc covering a discrete source which lies anywhere between 5 and 7 feet from the ground and from 1 to 30 meters away from the image sensing unit;
continually recording the cropped image input in a video buffer file, along with a time reference label;
detecting the target gesture in the buffer file by means of gesture recognition algorithms;
once the target gesture is detected, establishing the bearing of the gesturing subject based on the subject's known geometric position in the bi-dimensional circular range of the image processor chip memory;
conveying the bearing information to the visual bearing indicator positioned inside a vehicle and
triggering the sounding of an audio alarm positioned inside the vehicle.

32. Method according to claim 31 further comprising the step of reducing the height of the image band covered by the lens' vertical detection arc using software, so that the image actually forwarded for further processing is actually a narrower portion of the image actually acquired by the lens.

33. Method according to claim 31 wherein the specified gesture comprises the waving of a hand.

34. Method according to claim 31 wherein the specified gesture comprises the rising of an arm and waving of a hand at the end of said arm.
